(19) United States
(12) Patent Application Publication
(10) Pub. No.: US 2025/0214250 A1
(43) Pub. Date: Jul. 3, 2025

(54) DYNAMICALLY UPDATED AUTOMATIC MAKEUP APPLICATION

(71) Applicant: GEMMA ROBOTICS, INC., Haifa (IL)

(72) Inventors: Mira SHALAH-ABBOUD, Haifa (IL); Elizabeth Whitelaw WILLIAMS, Dallas, TX (US)

(21) Appl. No.: 18/852,246

(22) PCT Filed: Mar. 30, 2023
(86) PCT No.: PCT/IL2023/050334

§ 371 Date: Sep. 27, 2024

Related U.S. Application Data
(60) Provisional application No. 63/325,322, filed on Mar. 30, 2022.

(51) Int. Cl. B25J 9/16; A45D 44/00; B25J 11/00

(52) U.S. Cl. CPC B25J 9/1697; A45D 44/00; B25J 11/0075; A45D 2044/007

(57) ABSTRACT

A dynamically updated automatic makeup application system and method. The system comprises a machine with an airbrush mounted on a robotic arm movable in 5 degrees of freedom, an airbrush mounted on said robotic arm. The system implements a makeup application plan on a subject using the machine, to achieve a desired look for the subject, or perform corrective makeup. The system is configured to automatically and dynamically updating the makeup application plan during implementation thereof in response to identifying, based on the sensor readings, a movement of the subject. The airbrush is attachable to multiple alternative nozzles, with different air pressure levels and different materials in accordance with the makeup application plan. The system designs and fabricates four-dimensional (4D) stencils to be attached to the subject while applying makeup in accordance with the makeup application plan.

### CROSS-REFERENCE TO RELATED APPLICATION

This application claims the benefit of provisional patent application No. 63/325,322 filed Mar. 30, 2022, titled “AUTOMATIC MAKEUP APPLICATION”, which is hereby incorporated by reference in its entirety without giving rise to disavowment.

### TECHNICAL FIELD

The present disclosure relates to the automatic application of material on fine-line shapes and sharp edges in general, and to dynamically updated automatic makeup application, in particular.

### BACKGROUND

The application of makeup is a challenging task. Traditional makeup application methods tend to be messy, inaccurate, time-consuming, costly, and unhygienic. As an example, manual makeup application can consume several hours a week. It may also be unhygienic since makeup and brushes are often not cleaned properly after each use. Makeup can also be very expensive as multiple products from different makeup brands, colors and styles are required to achieve a desired look. Furthermore, the application of makeup, personally or by a professional requires skills, precision and materials that may not always be sufficient to accurately achieve the desired look.

New products, methods and techniques to help consumers save time and money, improve their hygiene when applying makeup, are in high demand.

### BRIEF SUMMARY

One exemplary embodiment of the disclosed subject matter is a method comprising: obtaining a makeup application plan, the makeup application plan comprises instructions for an automatic makeup applicator, the instructions, when implemented by the automatic makeup applicator, are configured to apply makeup materials on a subject in order to achieve a desired look for the subject; implementing by the automatic makeup applicator a portion of the makeup application plan; obtaining sensor readings from a sensor during said implementing, wherein the sensor is configured to monitor movements of the subject; in response to identifying, based on the sensor readings, a movement of the subject, updating the makeup application plan, whereby obtaining a dynamically updated makeup application plan; and implementing the dynamically updated makeup application plan or portion thereof in order to achieve the desired look for the subject while taking into account the movement of the subject and an implementation of the portion of the makeup application plan.

Optionally, the instructions of the makeup plan comprise an instruction to apply the makeup materials from a predefined location in space that is distant from a surface of the face by a defined distance; wherein said updating the makeup plan comprises modifying the instruction based on the movement of the subject so as to maintain the defined distance.

Optionally, the instructions comprise movement instructions that yield a 3D trajectory to be followed by the automatic makeup applicator in order to achieve the desired look; wherein the instructions comprise material application instructions, each of which indicating an application location, a material to be applied and application properties to be implemented by the automatic makeup applicator.

Optionally, said obtaining the makeup application plan comprises: obtaining a three-dimensional (3D) surface of a face of the subject; obtaining the desired look, wherein the desired look is determined based on a user input indicating a required result of makeup application on the face of the subject; and generating the makeup application plan based on the user input and based on the 3D surface of the face.

Optionally, said generating comprises: determining, for a target area in the 3D surface of the face, a material to be applied, an application property of an application of the material, and an application distance and orientation from which the material is to be applied on the target area, in order to achieve the desired look in the target area; and generating one or more instructions that are configured to cause the automatic makeup applicator to apply the material from the application distance and orientation on the target area using the application property.

Optionally, the application property comprises application pressure to be used when applying the material on the target area.

Optionally, said generating is performed with respect to a first target area and a second target area, wherein the application distance at the first target area is different than the application distance at the second target area.

Optionally, said generating is performed with respect to a first target area and a second target area, wherein the application property is a pressure to be used by automatic makeup applicator, wherein the application distance at the first target area is equal to the application distance at the second target area, wherein the pressure to be used by the automatic makeup applicator at the first target area is different than the pressure at the second target area.

Optionally, said generating is performed based on safety considerations, wherein the safety considerations include response time of the automatic makeup applicator to a movement of the subject, whereby ensuring sufficient time to avoid injury of the subject.

Optionally, said updating is performed to avoid injury of the subject.

Optionally the method further comprises: simulating an outcome of the process of applying the makeup application plan on the subject, wherein said simulating comprises simulating implementation of the instructions of the makeup application plan on a 3D model of the subject, whereby obtaining a simulated outcome depicting the subject wearing makeup in accordance with the makeup application plan, wherein said simulating the implementation of the instructions include simulating a first application of makeup on a target area of the subject and simulating a second application of makeup on the target area; and displaying the simulated outcome.

Optionally, said simulating comprises generating an intermediate simulated outcome depicting the subject wearing makeup in accordance with a partial application of the makeup application plan; and wherein said method comprises displaying the intermediate simulated outcome.

Optionally, the makeup application plan comprises an instruction to generate a four-dimensional (4D) stencil configured to be attached to the subject; wherein the method further comprises fabricating the 4D stencil; wherein said implementing is performed while the 4D stencil is attached to the subject.

Optionally, the 4D stencil is fabricated based on a 3D model of the subject.

Optionally, the automatic makeup applicator comprises an airbrush that is movable at 5 degrees of freedom, the airbrush is capable of translation movement in 3 axes and rotational movement in 2 axes.

Optionally, the airbrush having multiple nozzles having variable sizes and shapes.

Optionally, the makeup application plan defines a first application trajectory for a first nozzle and a second application trajectory for a second nozzle, wherein the makeup application plan defines a relative order of application between the first nozzle and the second nozzle.

Another exemplary embodiment of the disclosed subject matter is a machine comprising: a robotic arm movable in 5 degrees of freedom, the 5 degrees of freedom comprise translation movement in 3 axes and rotational movement in 2 axes; an airbrush mounted on said robotic arm; a sensor for monitoring movement of a subject; and a control unit for controlling movement of said robotic arm in accordance with a makeup application plan, said control unit is further configured to control application of said airbrush in accordance with the makeup application plan, wherein said control unit is configured to modify the makeup application plan based on sensor readings from said sensor.

Optionally the machine further comprises an air compressor, said air compressor is configured to cause application of material via said airbrush, wherein said control unit is configured to instruct said air compressor to provide different air pressure levels in accordance with the makeup application plan.

Optionally the machine further comprises a material mixer for providing a material to be applied by said airbrush, wherein the makeup application plan defines different materials to be mixed for applying makeup on the subject.

Optionally, said airbrush is attachable to multiple alternative nozzles having different sizes and shapes, thereby enabling different application patterns by said airbrush.

Optionally, said machine is configured to automatically attach and detach nozzles from said airbrush.

Optionally, said machine is coupled to a stencil fabricator for fabricating a 4D stencil that is configured to be attached to the subject while applying makeup in accordance with the makeup application plan.

Optionally the machine further comprises a chinrest and a forehead rest.

Optionally the machine further comprises a proximity sensor monitoring a distance of said airbrush from physical objects.

Yet another exemplary embodiment of the disclosed subject matter is a computerized apparatus having a processor, the processor being adapted to perform the steps of: obtaining a makeup application plan, the makeup application plan comprises instructions for an automatic makeup applicator, the instructions, when implemented by the automatic makeup applicator, are configured to apply makeup materials on a subject in order to achieve a desired look for the subject; implementing by the automatic makeup applicator a portion of the makeup application plan; obtaining sensor readings from a sensor during said implementing, wherein the sensor is configured to monitor movements of the subject; in response to identifying, based on the sensor readings, a movement of the subject, updating the makeup application plan, whereby obtaining a dynamically updated makeup application plan; and implementing the dynamically updated makeup application plan or portion thereof in order to achieve the desired look for the subject while taking into account the movement of the subject and an implementation of the portion of the makeup application plan.

### THE BRIEF DESCRIPTION OF THE SEVERAL VIEWS OF THE DRAWINGS

The present disclosed subject matter will be understood and appreciated more fully from the following detailed description taken in conjunction with the drawings in which corresponding or like numerals or characters indicate corresponding or like components. Unless indicated otherwise, the drawings provide exemplary embodiments or aspects of the disclosure and do not limit the scope of the disclosure. In the drawings:

FIGS. 1A-1C show schematic illustrations of an exemplary machine, in accordance with some exemplary embodiments of the disclosed subject matter;

FIGS. 2A-2B show flowchart diagrams of methods, in accordance with some exemplary embodiments of the disclosed subject matter;

FIGS. 3A-3B show flowchart diagrams of methods, in accordance with some exemplary embodiments of the disclosed subject matter;

FIGS. 4A-4E show schematic illustrations of an exemplary architecture, in accordance with some exemplary embodiments of the disclosed subject matter;

FIG. 5 shows schematic illustrations of an exemplary simulation, in accordance with some exemplary embodiments of the disclosed subject matter and

FIG. 6 shows a block diagram of an apparatus, in accordance with some exemplary embodiments of the disclosed subject matter.

### DETAILED DESCRIPTION

One technical problem dealt with by the disclosed subject matter is to enable an efficient automatic application of makeup, both for professional and personal use. Makeup application, specifically traditional, regular or manual makeup application, may be time-consuming, requires skills, abilities and techniques. Furthermore, makeup application may be unhygienic, as tools utilized therefore, such as brushes and sponges, may accumulate bacteria, even if it's designated for personal use, let alone, using of the same tools for different users.

On the other hand, existing automatic or semi-automatic makeup tools or devices that have been developed to simplify the process and provide accurate and consistent makeup application, are very basic, lack many abilities, inaccurate, unsafe and expensive. In some cases, the makeup application may be disrupted or the subject may be injured, ending with sub-optimal results, or even worse.

In some exemplary embodiments, airbrush techniques may be utilized for material application on surfaces, such as paint materials and the like. Airbrush technique may be a freehand manipulation of the airbrush, medium, air pressure, distance, or the like, from the surface being sprayed in order to produce a certain predictable result on a consistent basis with or without shields or stencils. Airbrush may be used for art and illustration, pre-digital photo retouching, painting murals, makeup application, temporary tattoos, nail art, clothing industry, automotive industry, or the like. Airbrush makeup may be a makeup sprayed onto the skin using an airbrush machine, from a relative distance instead of being applied directly through contact, such as when using sponges, brushes, fingers, or the like. Some airbrush systems use compressors to create airflow through a hose connected to a trigger-controlled spray-painting gun. The airbrush pressure can be adjusted to apply various types of makeup, such as lighter, heavier, or more detailed styles. An airbrush system may be utilized both in professional applications and in personal, in-home use, such as by smaller airbrush systems designed to work at a lower pressure than systems used in professional applications.

In some exemplary embodiments, airbrush techniques may be utilized for makeup application, as being more hygienic, long lasting, and natural looking. However, self-application of airbrush makeup may be a very complicated and hard multi-tasking application. The airbrush tool may be required to be held by hand, while other organs may be required to operate and coordinate for operating thereof. The hand and arm may be required to move along trajectories in 3D space, changing the location and orientation of the airbrush. The index finger may be required to control the flow of makeup by pulling the airbrush trigger. The eyes may be required to continuously track the moving airbrush and the sprayed makeup. All these tasks, which require a high degree of accuracy, may become even harder while applying makeup in sensitive locations, such as when applying eyeshadow, for example, as one eye must be completely closed during the application; or, as another example, while applying makeup to the under-eye area, due to the risk of spraying makeup into the eye. As a result, airbrush makeup may usually be applied by professional makeup artists who have received special training in the airbrushing technique, and may not be feasible for personal use.

Another technical problem dealt with by the disclosed subject matter is to provide an accurate application of makeup materials to achieve a desired look. In some exemplary embodiments, automatic application of material on non-static surfaces in general, and on human body or face, and using airbrush techniques, in particular, may be challenging due to the difficulty in accurately adjusting the application means, the difficulty keeping the user static without movement, or the like. A makeup application method that takes into account the movement of the subject during the application process to achieve the desired look for the subject, may be needed.

Additionally or alternatively, application of makeup with an airbrush is supposed to give a smooth result. This kind of application may be good enough to fit for makeup where a natural, smooth, airbrushed result is desired. However, some parts of the makeup application, like eyeliner and lip liner may require a more precise application with sharp and defined edges or fine lines. In some exemplary embodiments, airbrush artists who apply manual airbrush drawing or paint material may usually draw such fine lines either by removing the airbrush cap (thus exposing the airbrush needle), or by spraying the material with the needle almost touching the paper or canvas. Such technique may not be practical for automatic makeup applications as it may not be safe to have a needle this close to a user's face, let alone a user's eyes. Airbrush makeup artists, on the other hand, who manually apply makeup using airbrush, may utilize stencils. The stencils may be general or generic prepared stencils, generated by airbrush makeup manufacturers, such as general stencils included in any airbrush makeup starter kit, or the like, in order to draw fine shape. For each application such as eyeliner, eyebrow definition, lip definition, or the like, a fixed, generic set of stencils may be provided. As an example, a few stencils with different shapes of eyebrow, or a few different widths and shapes for an eyeliner. Such stencils are very challenging to use on oneself; They rarely fit the user well. Such stencils may be made of plastic or other similar hard materials; may not be flexible, and may not easily fit the user's face. As an example, the shape of the eyeliner stencil may not be adapted to the user's eye shape. As a result, a lot of maneuvering is required to fit those stencils during airbrush makeup application, requiring the makeup artist to move and adjust the stencils, until the desired result is obtained.

Yet another technical problem dealt with by the disclosed subject matter is to enable an accurate corrective makeup adapted for different users in potentially different situations. One of the most rewarding aspects as a makeup artist is creating an illusion or camouflaging using makeup to correct imperfections, especially in the face region, to enable reaching an accurate desired look. Such imperfections may comprise face dissimilarity, skin imperfections, pigmentation, scars, unsuitable sizes of certain organs, or any other facial defects, such as acne, burns, vitiligo, rosacea, age spots, birthmarks, dark eye circles, or the like. Corrective makeup may be a technique that makes use of light and dark shades and colors to highlight and contour features, creating the effect of balance and proportion, or the like. Dark shades may appear further away and lighter shades may appear closer. Illusions of shapes may be created using dark and light shades in the right place next to one another. As an example, a highlight or a light shade may emphasize a feature and contouring a dark shade may minimize a feature. As another example, A light color makes an object looks forward and a dark color may bring it back to the foreground. As yet another example, accurate contouring may create accurate shadows that help defining certain areas. Corrective makeup requires accurate identification of the areas of a person's face which need to have their appearance reduced or enhanced by makeup. It may be hard to carry out the identification process without training, skill, and expertise, and without the right measuring tools. As an example, corrective makeup may be required in certain situations requiring accurate measurements of the face, such as when the heights of the nose and forehead are the different, or when the eyes are separated by a distance greater than the width of one eye, or the like. However, identifying those features and accurately carrying out the correction with makeup is challenging. Manual corrective makeup, besides being usually inaccurate, may require practice and patience, both in selecting the correct blending of colors and material and application of such materials in accurate manner.

One technical solution is an automatic airbrush makeup application system that enables an automatic application of makeup to achieve a desired makeup look, based on user input, that may be dynamically updated during the application process. In some exemplary embodiments, the desired look may be obtained based on direct user input, such as a photo of a desired look, a selection of a look from a catalogue, or the like. Additionally or alternatively, the desired look may be generated manually or automatically based on user input, in accordance with the subject's face. The user may utilize a Graphical User Interface (GUI) showing a simulation of the subject's face, to indicate regions in which makeup is to be applied, makeup color, style, brush type, application technique, or the like. The user may start from scratch or from an initial state, that may be automatically determined.

In some exemplary embodiments, a visual input capturing the surface on which the makeup material to be applied thereon, such as a face of a subject, a neck of the subject, a chest of the subject, or the like, may be obtained. The visual input may be obtained from visual sensors monitoring the subject in real time, such as a camera, a scanner, range imaging sensors, or the like. Additionally or alternatively, the visual input may be an initial photo of the subject, from which properties thereof may be extractable. In some exemplary embodiments, the visual input may be analyzed to determine properties of the application surface, such as a structure (e.g., facial structure, structure of the object or an organ, or the like), color of the surface (e.g., user's skin color, background color, or the like), texture, or the like. Additionally or alternatively, the visual input may be analyzed to determine locations or positioning of components of the surface, such as coordinates of points of interest, boundaries, exact locations of facial features, dimensions, reference points, or the like. As an example, coordinates of the eyes, nose, eyebrows, lips, or the like, may be identified. In some exemplary embodiments, the analysis may be performed using image analysis techniques, machine learning, geometric analysis, or the like.

In some exemplary embodiments, the system may be configured to determine an optimized path (also referred to a trajectory) for the material application, e.g., an airbrush application path, a makeup application process path, or the like. In some exemplary embodiments, the system may be configured to calculate trajectories in 3D space that emulate the movement of human expert in manually applying the material on the surface to achieve the desired result. As an example, the system may be configured to calculate trajectories in 3D space that emulate the hand movement of an airbrush makeup artist to achieve the chosen makeup look. Each trajectory may comprise a collection of oriented 3D points in 3D space, representing the location and orientation of the makeup applicator.

In some exemplary embodiments, an automatic machine may be configured to apply the material on the surface in accordance with the calculated path. The automatic machine may be a Computer Numerical Control (CNC) machine, airbrush machine, a machine with an automatic airbrush equipment, or the like. One or more automatic machines may be configured to follow the calculated path and trajectories and apply (e.g., spray) the material (e.g., the makeup) on the surface (e.g., the user's face).

Additionally or alternatively, the automatic machine may be a robotic system designed for automated makeup application. The automatic machine may consist of a robotic arm that can move in exactly five degrees of freedom, including translation movement in three axes and rotational movement in two axes. It is noted that a rotational movement in the third axes may also be implemented in some embodiments. In some exemplary embodiments, one or more airbrushes may be mounted on the robotic arm, and used for applying makeup on the subject. The automatic machine may comprise a sensor for monitoring the movement of the subject and a control unit that controls the movement of the robotic arm and the application of the airbrush in accordance with a makeup application plan.

In some exemplary embodiments, the control unit may be capable of modifying the makeup application plan based on sensor readings from the sensor, which allows for adjustments to be made to the makeup application in real-time. Additionally or alternatively, the automatic machine may comprise a material mixer for providing different materials to be applied by the airbrush, enabling the application of a wide range of makeup products. The airbrush may also be attachable to multiple alternative nozzles of different sizes and shapes, allowing for different application patterns to be achieved.

In some exemplary embodiments, a system may be configured to calculate and instruct the machine to generate the combination of material to be used along each trajectory, in order to provide a customized color or formula to be applied (e.g., sprayed, printed, or the like) on the surface. The customized color or formula may be calculated based on the required result (e.g., the chosen makeup look), the surface background color (e.g., the user's skin tone), or the like. The customized color or formula may be obtained by mixing materials (e.g., base makeup shades) that are stored in designated reservoirs associated with the machine. In some exemplary embodiments, the materials may be mixed in accordance with Cyan, Magenta, Yellow, and Key (Black) (CMYK) color model and white color model. The system may be configured to produce any shade by mixing CMYK base shades, thus enabling reaching the desired look with minimal amount and types of material. Such may have a fundamental effect on makeup application, as enabling generating any required look using a limited variety of makeup materials and colors. It is noted that the disclosed subject matter is not limited to a specific color model and other color models may also be applicable.

In some exemplary embodiments, the system may be configured to apply the material layer-by-layer in order to achieve the required result (e.g., chosen makeup look). Each layer may be separately applied, using separately calculated trajectories. Different composition of materials may be applied in each layer.

Another technical solution is to dynamically update the makeup application plan based on sensor information monitoring movements of the subject during application of the makeup material. The makeup application plan may be updated dynamically, in response to identifying a movement of the subject that may affect the makeup application process. In some exemplary embodiments, the system may be configured to continuously track user movements of the subject during application of the makeup material and dynamically adjust the calculated trajectories based on such movements. The system may also be configured to dynamically stop or pause the makeup process, adjust the automatic makeup applicator, or the like, based on the movements of the subject. The movement of the subject may be tracked using motion sensors, visual sensors, Range of Motion (ROM) sensors, or the like.

Yet another technical solution is dynamically updating the makeup application plan based on user input regarding a real-time simulation of the outcome of the makeup process based on the application plan.

In some exemplary embodiments, the system may be configured to provide a step-by-step Augmented Reality (AR) or Virtual Reality (VR) preview of the layer-by-layer application on the surface using graphical simulation based of the calculated trajectories, shades, and formulas, such as a step-by-step AR or VR preview of the chosen makeup look on the 3D model of the user's face. The graphical simulation may simulate application of real makeup based on real trajectories and movements, both of the user and the application machine.

Yet another technical solution is to generate customized self-folding 3D stencils using 4-dimensional (4D) printing technology. The customized self-folding 3D stencils may be automatically personalized and adapted to the shape of the user's face, the required result, or the like. The customized self-folding 3D stencils may be located (automatically by the machine, or manually by the user) on the exact location, and utilized to draw fine lines and sharp edges with an airbrush. This method sets forth an alternative to traditional 2D generic stencils.

In some exemplary embodiments, customized self-folding 3D stencils may be custom fit to the user's face. The customized self-folding 3D stencils may be created based on analysis of a visual input scanning user's face.

In some exemplary embodiments, the customized self-folding 3D stencils may be a 2D shape capable to morph into different forms in response to environmental stimulus, with the 4th dimension being the time-dependent shape change after the printing. The customized self-folding 3D stencils may be created using programmable 4D printing, wherein after the fabrication process, the printed stencils react with parameters within the environment (humidity, temperature, voltage, or the like) and change its form accordingly. The self-folding stencils can conform perfectly to the user's face and enable maneuver-free and much less challenging material application.

In some exemplary embodiments, 4D printing may be configured to encode self-actuating deformation during the printing process, such that objects can be fabricated flat and then transformed into target 3D shapes. 4D printing may include printing a 3D structure, or a 2D structure capable of taking 3D form, such as by folding the 2D surface. The 4-th dimension involved in the 4D printing may be the time dimension, as the 3D object (e.g., 3D printed object, 2D printed surface that is folded to a 3D object, or the like) may change its form over time. The change of the form may be caused by heat, contact with another material, or the like. As an example, a Fused Deposition Modeling (FDM) printing technique may be utilized to extrude melted thermoplastic through a narrow nozzle, which stretches the material along the printing direction. The pre-stretch causes the material to shrink along the printing direction under heat. In addition to the shrinkage direction, the amount of shrinkage may be controlled through the printing thickness of each layer. As another example, a printed 2D flat sheet, e.g., the personalized stencil, may uniformly be heated with a hot water bath at a high temperature, such as about 90° C., and self-transform into the target 3D surface. As yet another example, the printed stencils (2D or 3D) may automatically deform when getting close to the user's face, or being in contact with a basis material applied to the face using the airbrush machine, or the like. In some exemplary embodiments, barcodes may be printed on the 2D stencils to aid in locating the stencil using a camera and computer vision algorithms.

Yet another technical solution is to utilize automatic airbrushing to dynamically perform corrective makeup. In some exemplary embodiments, the system may be configured to automatically detect facial asymmetry, pigmentation, or any other deficiencies in the face. The system may be configured to automatically determine a corrective process and apply it on the user face using airbrush techniques. The corrective process may comprise utilization of multiple 3D trajectories and paths, utilization of different types of materials, or the like. The corrective process may be applied on the user's face using automatic application of makeup procedures and techniques, e.g., techniques that use the golden ratio to harmonize facial features. Corrective contouring may be used to bring more balance to the face, create more symmetry for the features, or change the shape of the features or face altogether, like minimizing forehead size by applying a darker shade around the edges of the forehead when the size of the forehead exceeds a certain threshold with respect to the size of the entire face, or making a nose appear slimmer or shorter when the length of the nose exceeds a certain threshold, or hiding a double chin when such is detected, and so on. When two areas should appear to be equal in length but are not in fact, dark shades may be used to subside a portion of one area and thus create the illusion that this area is shorter, while lighter shades may be used to emphasize the equal length parts.

It may be noted that the solutions, products, methods and systems are described with respect to airbrush makeup application. However, each of the technical solutions, products, methods and systems may be adapted and applicable for other makeup application techniques, such as 3D-printing application techniques, sponge-based makeup applicators, or the like. Additionally or alternatively, each of the technical solutions, products, methods and systems may be adapted and applicable for other uses of airbrush techniques, such as in art application, painting, drawing, temporary tattoo, nail art, clothing industry, automotive industry, or the like.

One technical effect of utilizing the disclosed subject matter is providing an efficient, hygienic and accurate application of makeup materials to achieve a desired look, while overcoming challenges of manual airbrush makeup. The disclosed automatic application of airbrush makeup overcome challenges of both automatic and manual existing makeup techniques and provides an accurate, fast, and hygienic makeup application. The disclosed automatic application of airbrush makeup may utilize a freehand technique to apply makeup while manipulating aspects such as distance and air pressure to produce certain effects and coverage. Furthermore, the disclosed subject matter provides a stencil fabricator for creating 4D stencil that can be attached to the subject's face during makeup application, to enable providing an advanced and more automated solution for applying makeup with precision and accuracy, while allowing for customization, personalization, and flexibility in the makeup application process.

Another technical effect of utilizing the disclosed subject matter is to eliminate human intervention in makeup selection, appropriation, application, and cleanup, while performing these tasks accurately, cost-effectively, and in an acceptable hygienic manner. The disclosed automatic application of airbrush makeup may be particularly useful for people who want to achieve a flawless, long-lasting makeup application without having to spend a lot of time or effort on the process.

Yet another technical effect of utilizing the disclosed subject matter is to enable a free movement of the subject during automatic makeup application, without endangering the subject. The disclosed subject matter enables automatically applying makeup in fine-line and precise shapes, utilizing airbrush techniques, without requiring a means to keep the user static without movement. Additionally or alternatively, a chinrest or a forehead rest may be utilized to stabilize the subject during the makeup application process, without limiting movement thereof, or requiring the subject to sit in a certain position during the makeup application process.

Yet another technical effect of utilizing the disclosed subject matter is to provide automatic corrective makeup applicators that use airbrush technologies, the 5-degrees of freedom movement that aids in blending and application, without the use of manual tools or expert knowledge.

Yet another technical effect of utilizing the disclosed subject matter is aiding persons with a disability which limits or inhibits their ability to self-apply makeup. A vocal interface may be used to operate and communicate with the machine and help make the makeup process more inclusive for people with disabilities.

The disclosed subject matter may provide for one or more technical improvements over any pre-existing technique and any technique that has previously become routine or conventional in the art.

Additional technical problems, solutions and effects may be apparent to a person of ordinary skill in the art in view of the present disclosure.

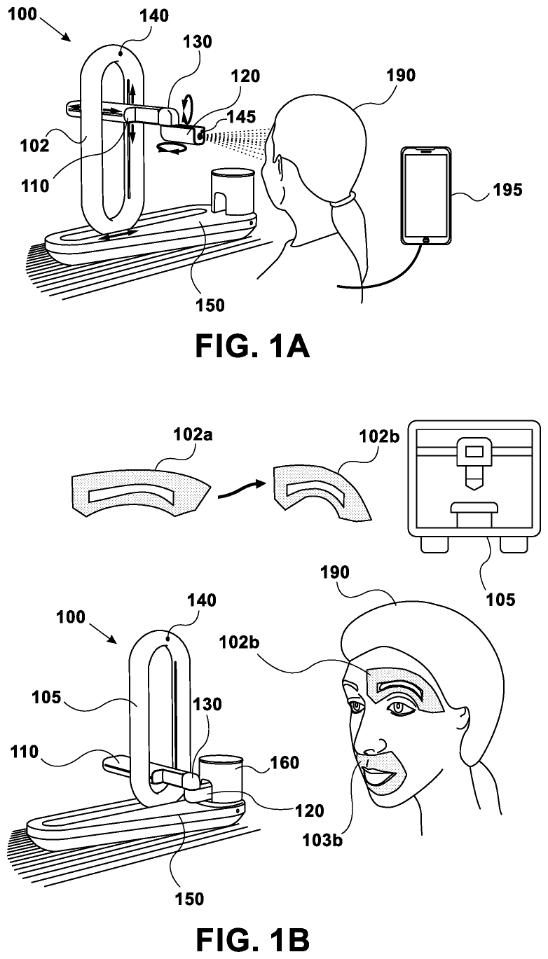

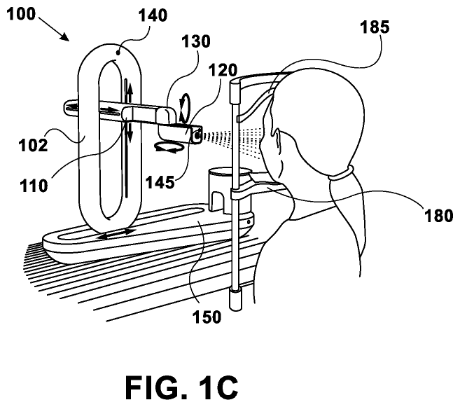

Referring now to FIG. 1A showing a schematic illustration of an exemplary machine, in accordance with some exemplary embodiments of the disclosed subject matter.

In some exemplary embodiments, Machine 100 may be an automatic makeup applicator that utilizes airbrush technology for applying makeup on surfaces, organs, bodies, or the like, such as on the face of Subject 190. Machine 100 may be configured to use airbrush technology to provide a quick, easy, and precise way to apply makeup, with a professional-looking finish.

In some exemplary embodiments, Machine 100 may comprise a Robotic Arm 110 movable in 5 degrees of freedom. Robotic Arm 110 may be designed to move in 3 axes translation movement, e.g., linear movement, such as forward/backward (z-axis), up/down (y-axis), and left/right (x-axis), in a plane facing the face of Subject 190. The 3 axes translation movement together with a pitch and yaw rotation of the arm or wrist may be utilized to emulate a movement of a hand of a makeup professional. the 3 axes movement may be enabled by a two axes movement of Robotic Arm 110, e.g., forward/backward (z-axis), up/down (y-axis), and by a movement of a Body 102 holding Robotic Arm 110 in left/right (x-axis). Additionally or alternatively, Robotic Arm 110 movable in 4 degrees of freedom. Robotic Arm 110 may be designed to move in 3 axes translation movement, e.g., linear movement, such as forward/backward (z-axis), up/down (y-axis), and left/right (x-axis), in a plane facing the face of Subject 190. The 3 axes translation movement together with yaw rotation of the arm or wrist may be utilized to approximate a movement of a hand of a makeup professional. The 3 axes movement may be enabled by a two axes movement of Robotic Arm 110, e.g., forward/backward (z-axis), up/down (y-axis), and by a movement of a Body 102 holding Robotic Arm 110 in left/right (x-axis).

Additionally or alternatively, Robotic Arm 120 may comprise a Wrist 130 with one or two joints. One joint may be configured to connect between two portions of Robotic Arm 120, a first portion configured to move in forward/backward (z-axis) and a second portion configured to move in up/down (y-axis) and left/right (x-axis). Additionally or alternatively, Robotic Arm 110 may be directly enabled with the 3 axes movement, without relying on a movement of another component of Machine 100.

In some exemplary embodiments, an Air Brush 120 may be mounted on Robotic Arm 110. Robotic Arm 110 may be configured to enable a rotational movement in 2 axes of Airbrush 120. Additionally or alternatively, Airbrush 120 may be connected to Robotic Arm 110 using Wrist 130 (such as using the second joint) thereby enabling the rotational movement thereof. Additionally or alternatively, Robotic Arm 110 may be directly enabled with the 5 axes movement, without relying on a movement of another component of Machine 100.

In some exemplary embodiments, Airbrush 120 may be configured to utilize compressed air to spray makeup onto the skin of Subject 190. Airbrush 120 may have an access to a refillable reservoir for the makeup. Airbrush 120 may be configured to spray the makeup material onto the skin in a fine mist, creating an even and natural-looking finish. In some exemplary embodiments, Airbrush 120 may be associated with an air compressor configured to cause application of material from Airbrush 120. The air compressor may be an integrated component of Airbrush 120, may be connected to Airbrush 120, may be connected to other components of Machine 100, or the like.

In some exemplary embodiments, Airbrush 120 may be attachable to multiple alternative nozzles having different sizes and shapes. The different nozzles may enable different application patterns by Airbrush 120. Machine 100 may be configured to automatically attach and detach nozzles from Airbrush 120. Additionally or alternatively, Airbrush 120 may be attachable to other types of attachments for applying different types of makeup, such as foundation, blush, and highlighter. The attachments would be interchangeable, allowing for versatility in application.

In some exemplary embodiments, Airbrush 120 may be associated with a depth camera. The depth camera may be located at the center of Machine 100, such as near or into Sensor 140. Sensor 140 may be or may comprise the depth camera. Additionally or alternatively, the depth camera may be an integrated component of Airbrush 120, may be a separated sensor located on other locations of Machine 100, or the like. The depth camera may be configured to scan the face of Subject 190, in order to keep a predefined distance from the face of Subject 190, in accordance with the makeup application plan.

Additionally or alternatively, Machine 100 may comprise other sensors in different locations, such as Sensor 145 located on at the bottom right of the Machine 100, sensors on Wrist 130 (not shown), multiple in a non-stationary location (not shown), or the like. Similar to Sensor 140, Sensor 145 may comprise a depth camera. The combination of two or more sensors or depth cameras in different locations may enable Machine 100 to deal with possible occlusions, when one camera or sensor is occluded a second camera or sensor are being placed at a different location that would not be occluded may be utilized.

In some exemplary embodiments, Machine 100 may comprise a Control Unit 150 for controlling movement of Robotic Arm 110 in accordance with a makeup application plan. Control Unit 150 may be configured to control application of Airbrush 120 in accordance with the makeup application plan, the movement of Wrist 130, or the like. Additionally or alternatively, Control Unit 150 may be configured to modify the makeup application plan based on sensor readings from Sensor 140.

In some exemplary embodiments, Machine 100 may comprise a Sensor 140 for monitoring movement of Subject 190. Sensor 140 may be a visual sensor, a motion sensor, a combination thereof, or the like. Sensor 140 may be designed to detect and measure the movement of objects, people, or animals within their range, in particular, the movement of Subject 190, the movement of certain organs, portions, or points of Subject 190, such as the face, the eyes, the forehead, the chest, the neck, the shoulders, or the like.

In some exemplary embodiments, Sensor 140 may comprise cameras or other optical devices configured to continuously capture images of Subject 190 and analyze them to detect movement. The analysis may comprise computer vision and image analysis techniques. Additionally or alternatively, Sensor 140 may comprise other types of motion sensors. As an example, Sensor 140 may comprise Passive Infrared (PIR) sensors configured to detect changes in infrared radiation caused by movement of Subject 190. As another example, Sensor 140 may comprise ultrasonic sensors configured to emit high-frequency sound waves that bounce off the surface of Subject 190 and detect movement based on return time. As yet another example, Sensor 140 may comprise microwave sensors configured to emit microwave signals and measure the reflection of these signals off nearby objects.

In some exemplary embodiments, a proximity sensor (not shown) may be attached to a cap of Airbrush 120 in order to monitor situations where the airbrush gets too close to an object, in particular the face of Subject 190. Additionally or alternatively, other sensors external to Machine 100, such as sensors in Device 195, such as cameras, microphones, or the like, may be utilized as sources of input and signals to Machine 100. As an example, in one embodiment of Machine 100, Device 195 may be mounted in a designated location in Machine 100, and the cameras of Device 195 may be utilized to track User 190 in real-time. Additionally or alternatively, a microphone of Device 195 may be utilized to transfer vocal or verbal communication between Subject 190 and Machine 100.

Additionally or alternatively, Control Unit 150 may be configured to adjust settings to control the amount of makeup being sprayed by Airbrush 120, as well as the pressure of the air provided by the air compressor. This would allow for customization based on the user's desired coverage and finish. Control Unit 150 may be configured to instruct the air compressor to provide different air pressure levels in accordance with the makeup application plan.

In some exemplary embodiments, Machine 100 may be coupled to Device 195 of Subject 190 or other user monitoring or controlling the makeup application process, such as using a Wi-Fi connection, Bluetooth connection, or the like. Device 195 may comprise a display means, such as a screen of computing device, or any User Interface UI means, such as via a mobile device, a designated application, or the like. Device 195 may be utilized for monitoring and reviewing the makeup application plan by simulation thereof on a 3D virtual model if the face of Subject 190. Device 195 may be utilized to display a preview of the result of spraying each calculated shade by following its corresponding trajectory on a virtual 3D model of the face OF Subject 190, such as using graphical simulation, via a video, or the like.

Additionally or alternatively, Device 195 may be utilized to communicate with a user controlling the makeup application process, such as a makeup professional. The makeup professional may be enabled to manually modify the makeup application plan, the dictation of trajectories in a VR or remote setting, or the like.

Additionally or alternatively, Subject 190 or any other user on charge may be enabled to create, upload, or pick a look from a preset catalogue, using Device 195, to provide an input to Machine 100, to manually update the makeup application plan, or the like.

It may be noted that Subject 190 or any other user controlling the makeup application process can stop the makeup procedure at any moment, such as using Device 195, directly shutdown Machine 100 or stopping/maneuvering movement of components of Machine 100, or the like.

Machine 100 may include an emergency stop button (not shown) that subject 190 may press at any given moment while machine 100 is operating to stop its operation.

Referring now to FIG. 1B showing a schematic illustration of an exemplary machine, in accordance with some exemplary embodiments of the disclosed subject matter.

In some exemplary embodiments, Machine 100 may comprise a Color Mixing System 160 e.g., a color or material mixer) for providing a material to be applied by Airbrush 120. Color Mixing System 160 may be configured to dispense different materials inside the cup of Airbrush 120 for applying makeup on Subject 190 in accordance with the makeup application plan. Color Mixing System 160 may be configured to accurately dispense CMYK and other shades which reside in designated reservoirs within the Color Mixing System 160. Back bubbling air into the airbrush cup may then be used to mix the dispensed materials and obtain the corresponding shade on demand for each trajectory.

In some exemplary embodiments, Machine 100 may be configured to automatically refill the cup of Airbrush 120 with makeup material from Color Mixing System 160 in accordance with the makeup application plan. The makeup material defined for each area in the face, such as customized makeup shade, may be transferred to Airbrush 120 via Body 102 and Robotic Arm 110. Additionally or alternatively, Airbrush 120 may be designed to move towards Color Mixing System 160 to fill the makeup material.

In some exemplary embodiments, Machine 100 may be coupled to a Stencil Fabricator 105 for fabricating a 4D stencil that is configured to be attached to Subject 190 while applying makeup in accordance with the makeup application plan. Stencil Fabricator 105 may be integrated in Machine 100, may be separated from Machine 100 and connected thereto wire or wirelessly, or the like.

In some exemplary embodiments, Stencil Fabricator 105 may be configured to work offline and independently of Machine 100. Stencil Fabricator 105 may get the stencil geometry to fabricate and to be used with Machine 100 at a later time. The stencil geometry may be produced according to a facial scan of User 190 using Device 195, using sensor data from Machine 100, or the like.

In some exemplary embodiments, Stencil 102a may be fabricated using Stencil Fabricator 105 in accordance with the makeup application plan. It may be noted that the shape of Stencil 102a prior to being attached to the face of Subject 190 may be flat, however, its shape may be morphed such as into the shape of Stencil 102b when being attached to the face of Subject 190. It may be noted that more than one stencil can be attached to the face of Subject 190 simultaneously, such as Stencil 102b over the eyebrows and Stencil 103b around the mouth of Subject 190. Additionally or alternatively, the different stencils may be attached to the face of Subject 190 and detached therefrom separately, while applying different trajectories of the makeup application plan, while using different makeup materials, or the like.

Referring now to FIG. 1C showing a schematic illustration of an exemplary machine, in accordance with some exemplary embodiments of the disclosed subject matter.

In some exemplary embodiments, Machine 100 may utilize a Chinrest 180, or/and a Forehead Rest 185 to ensure that the face of Subject 190 is stationary and in the correct position for accurate makeup application. Chinrest 180 and Forehead Rest 185 may be components of Machine 100, may be separated therefrom, may be attachable thereto, or the like. Additionally or alternatively, Chinrest 180 and Forehead Rest 185 may be controlled by Control Unit 150, and adjusted in accordance with movement of Subject 190, or in accordance with the makeup application plan.

In some exemplary embodiments, Chinrest 180 is a small platform that supports the chin of Subject 190, while Forehead Rest 185 provides support for the forehead of Subject 190. Chinrest 180 and Forehead Rest 185 may be adjustable to fit different head sizes and shapes. Chinrest 180 and Forehead Rest 185 may be padded to ensure comfort during the makeup application process. Subject 190 may be asked to rest her chin on the Chinrest 180 and/or her forehead against Forehead Rest 185, to help to stabilize the head and ensure that the face, and particularly the eyes and the lips, are at the right distance from Machine 100 or Airbrush 120, or the like.

In some exemplary embodiments, Chinrest 180 may comprise a small groove or ridge designed to fit underneath the chin of Subject 190. This helps to prevent the chin from slipping forward and maintains the correct distance between the face of Subject 190 and relevant components of Machine 100. Additionally or alternatively, Chinrest 180 may comprise a small lip or edge that extends upward and presses against the underside of the chin of Subject 19 without interrupting the makeup application process, or covering the face of Subject 190. This provides further support and helps to prevent the face of Subject 190 from moving forward during the automatic makeup application.

Additionally or alternatively, Forehead Rest 185 may be designed to help limiting forward movement by providing a point of contact that Subject 190 can push against, which helps to keep the head and face in place. The combination of a groove or ridge on Chinrest 180 and Forehead Rest 185 may help limiting the movement of the face of Subject 190 forward while resting on Chinrest 180, ensuring that the face remains in the correct position for accurate makeup results.

Additionally or alternatively, additional supports such as earrests or side supports may be used to further stabilize the head and prevent movement during the makeup application process. The goal of these supports is to ensure that the head of the subject remains still during the makeup application process, or portions thereof, to ensure accurate application.

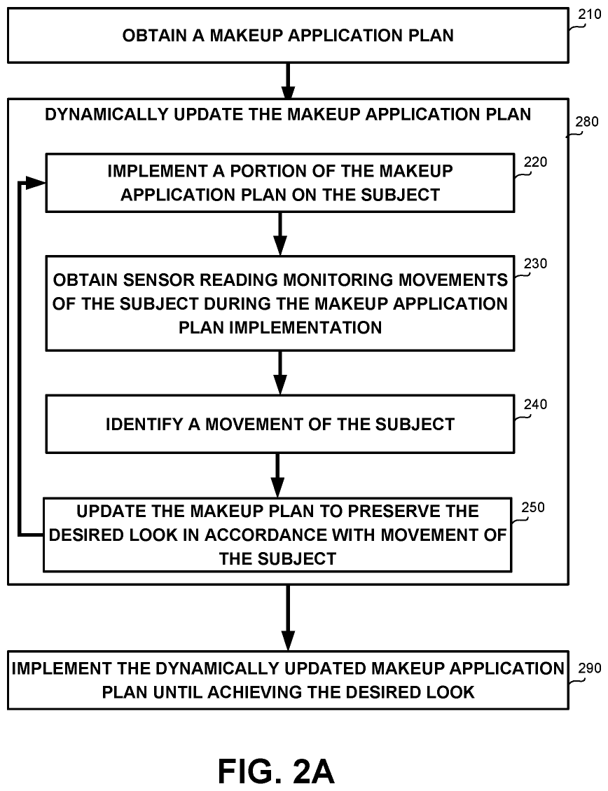

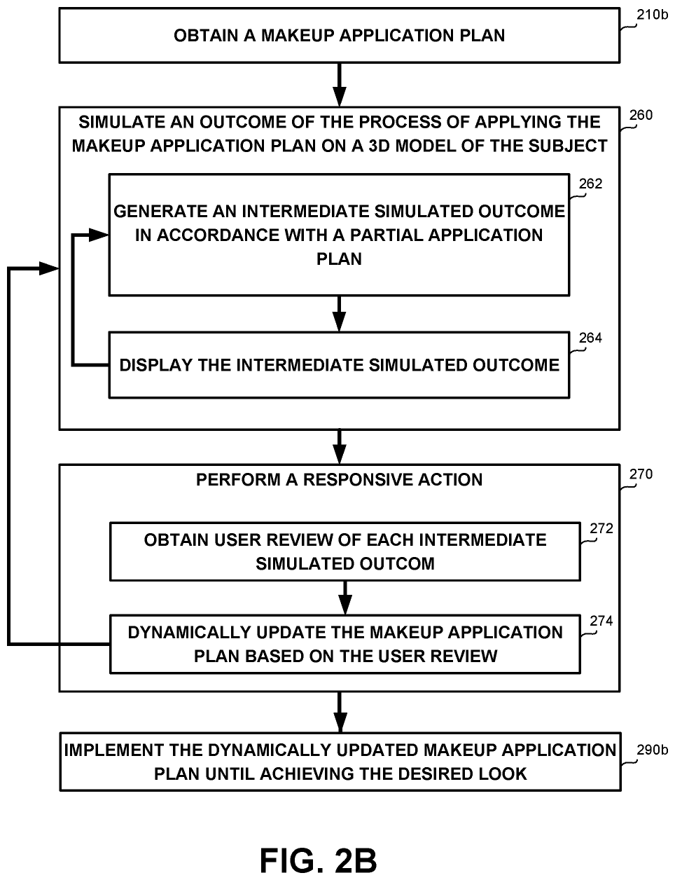

Referring now to FIG. 2A showing a flowchart diagram of a method, in accordance with some exemplary embodiments of the disclosed subject matter.

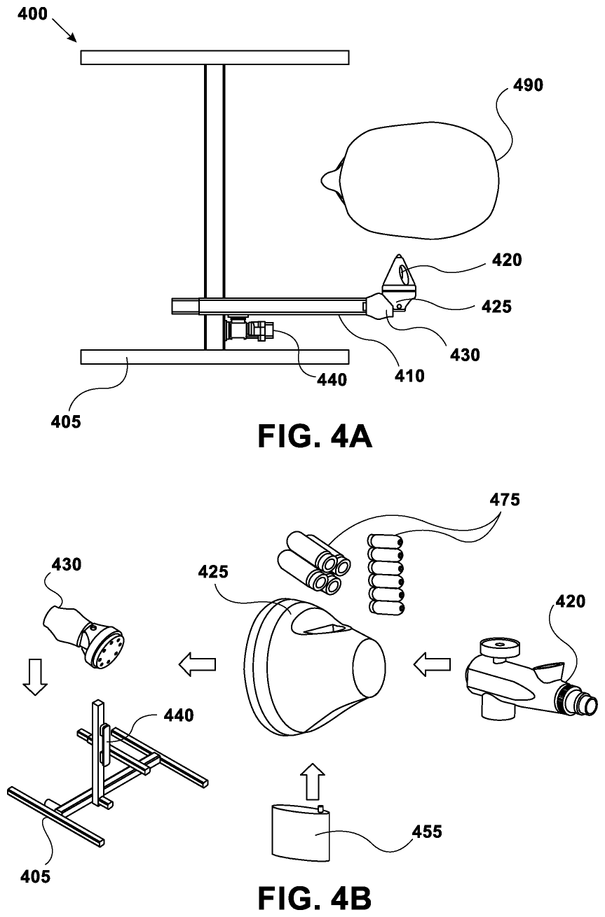

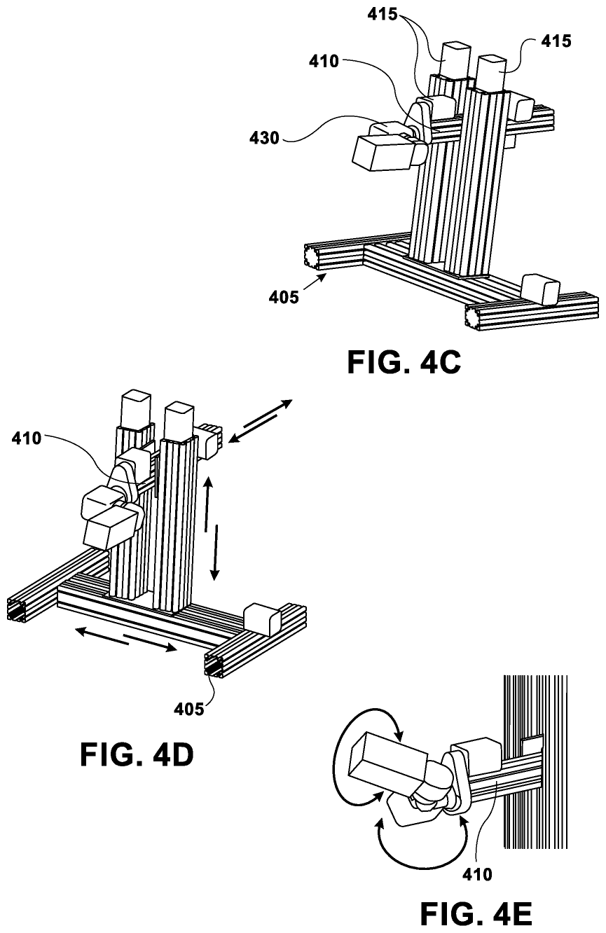

On Step 210, a makeup application plan may be obtained. In some exemplary embodiments, the makeup application plan may comprise instructions for an automatic makeup applicator to apply makeup materials on a subject in order to achieve a desired look for the subject. In some exemplary embodiments, the makeup applicator may be an automatic airbrush makeup application apparatus or a component thereof, such as the machine depicted in FIGS. 1A-1C, the machines depicted in FIGS. 4A-4E, or the like.

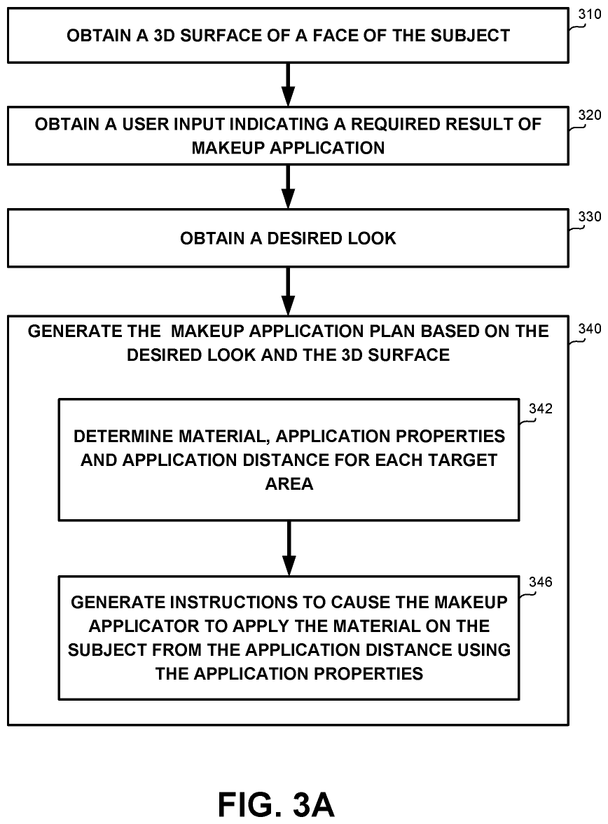

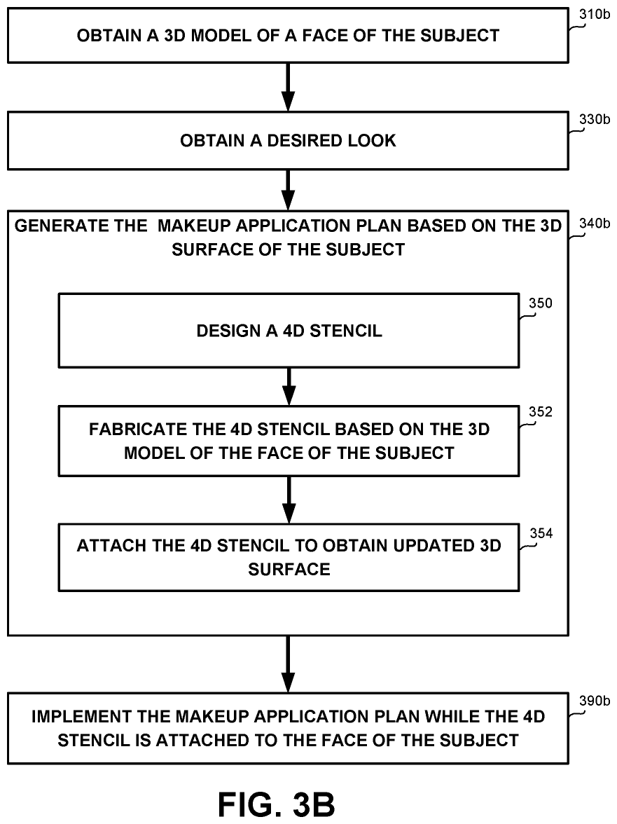

In some exemplary embodiments, the makeup application plan may be generated offline, may be dynamically updated, may be generated from scratch, or the like. As an example, the makeup application plan may be obtained using one or more of the methods described in FIGS. 3A-3B, or portions thereof. Additionally or alternatively, the makeup application plan may be automatically generated a similar manner to that described in U.S. Patent No. US20200285835 A1, filed Mar. 7, 2019, granted Jan. 31, 2023, and entitled “Systems and methods for automated makeup application”, which is hereby incorporated by reference in its entirety for all purposes without giving rise to disavowment.

In some exemplary embodiments, the instructions of the makeup plan may comprise instructions to apply the makeup materials from predefined locations in space that are distant from a surface of the face by a defined distance. Additionally or alternatively, the instructions may comprise movement instructions that yield a 3D trajectory to be followed by the automatic makeup applicator in order to achieve the desired look. Each instruction may comprise material application instructions to be applied in each location within the 3D trajectory. The material application instructions may be configured to indicate an application location, a material to be applied and application properties to be implemented by the automatic makeup applicator, or the like.

In some exemplary embodiments, the makeup application plan may be configured to define a plurality of application trajectories, each of which is configured to be applied separately, by the same makeup applicator with a relative order therebetween (e.g., one after the other, in layers, or the like), simultaneously by different makeup applicators, by different components of the makeup applicator, such as using different nozzles of airbrush, with different compositions of materials, or the like.

On Step 220, a portion of the makeup application plan may be implanted by the automatic makeup applicator. In some exemplary embodiments, the portion may comprise a predetermined number of instructions, such as one instruction, 2 instructions, 10 instructions, or the like. Additionally or alternatively, the portion may be defined based on a time, such as the portion applied in 1 millisecond, 50 milliseconds, 1 second, 10 seconds, or the like. Additionally or alternatively, the portion may not be a predefined portion of the makeup application plan, but rather, any portion of the makeup application plan that is implemented until a movement of the subject is detected.

On Step 230, sensor readings may be obtained from a sensor monitoring movements of the subject during the makeup application plan implementation. In some exemplary embodiments, one or more sensors may be configured to monitor the movements of a subject, that may affect the makeup application process, such as movements of the head, of the shoulders, of the neck, of certain organs in the face, or the like. The sensors may be motion sensors, visual sensors, or the like.

On Step 240 a movement of the subject may be identified based on the sensor readings. In some exemplary embodiments, the sensor readings may comprise visual readings capturing the subject. The sensor readings may be analyzed using computer vision techniques, visual analysis techniques, or the like, to detect the movement of the subject. As an example, the motion of certain organs or objects may be continuously tracked to detecting changes in the position, size, or shape of the objects in consecutive frames of the video. As another example, the movement may be identified based on changes in pixel values between consecutive frames. As yet another example, the movement may be detected using optical flow, based on a pattern of apparent motion of objects in an image, track the movement of image features, such as edges or corners, to estimate the direction and speed of movement in a scene, or the like.

On Step 280, the makeup application plan may be dynamically updated based on the movement of the subject, in a manner achieving the desired look for the subject despite the movement of the subject. In some exemplary embodiments, updating the makeup plan may comprise modifying the instruction based on the movement of the subject. In some exemplary embodiments, the distance of the makeup applicator from the face of the subject may be modified so as to maintain the defined distance. Additionally or alternatively, a whole trajectory (location of makeup applicator as a function of time) may be updated based on the movement of the subject. Additionally or alternatively, a relative time of reaching a certain location may be updated based on the movement of the subject, such as delaying the arrival of the makeup applicator to a certain location, modifying timings of reaching different target areas, or the like. Additionally or alternatively, a composition of the material to be applied may be updated.

Additionally or alternatively, the machine may be instructed to stop moving, the airbrush may be instructed to stop spraying by either turning off the air compressor or releasing the airbrush trigger, or both, or the like.

Additionally or alternatively, the makeup application plan may be dynamically updated based on the movement of the subject to avoid injury of the subject. As an example, to avoid getting too close to the surface of the face, especially in delicate areas, such as around the eyes.

On Step 290, the dynamically updated makeup application plan or portion thereof may be implemented to achieve the desired look taking into account the movement of the subject and an implementation of the portion of the makeup application plan.

Referring now to FIG. 2B showing a flowchart diagram of a method, in accordance with some exemplary embodiments of the disclosed subject matter.

On Step 210b, a makeup application plan may be obtained. In some exemplary embodiments, the makeup application plan may comprise instructions for an automatic makeup applicator to apply makeup materials on a subject in order to achieve a desired look for the subject.

On Step 260, an outcome of the process of applying the makeup application plan on the subject may be simulated on a 3D model of the subject. In some exemplary embodiments, the simulated outcome may depict the subject wearing makeup in accordance with the makeup application plan.

On Step 262, an intermediate simulated outcome depicting the subject wearing makeup in accordance with a partial application of the makeup application plan may be generated.

In some exemplary embodiments, the intermediate simulated outcome may be generated based on a 3D model or a digital image of the subject's face. The partial makeup application plan may be applied on a digital image or the 3D model of the subject's face using computer software, computer vision techniques, or the like, that emulate the makeup applicator actions.

On Step 264, the intermediate simulated outcome may be displayed to the user, such as on a computer screen, a mobile device, or any other display device accessible to the user or the subject, or the like. In some exemplary embodiments, the user may be enabled to zoom in and out or rotate the image of the subject's face to see the makeup application from different angles. This can help the user to make more informed decisions about the final makeup application. In some exemplary embodiments, the user may be enabled to choose from a variety of hairstyles to be used together with the result of the makeup application. This may help the user pick the look they like best with the makeup application.

On Step 270, a responsive action may be performed based on the simulated outcome.

On Step 272, a user review of intermediate simulated outcome may be obtained. In some exemplary embodiments, the user may be enabled to review the intermediate simulated outcome and make any necessary adjustments to the makeup application plan before continuing with the final makeup application. Additionally or alternatively,

On Step 274, the makeup application plan may be updated based on the user review.

On Step 290b, the dynamically updated makeup application plan or portion thereof may be implemented to achieve the desired look taking into account the movement of the subject and an implementation of the portion of the makeup application plan.

Referring now to FIG. 3A showing a flowchart diagram of a method, in accordance with some exemplary embodiments of the disclosed subject matter.

On Step 310, a 3D surface of a face of the subject may be obtained. In some exemplary embodiments, the 3D surface of the face of the subject may be determined based on a visual input capturing the subject. In some exemplary embodiments, the visual input may be obtained from visual sensors, such as a camera, a scanner, range imaging sensors, or the like. The visual sensors may be configured to scan the surface on which the required material is applied and properties thereof, such as a face, neck, or other organ of the user, a surface of an object, or the like.

In some exemplary embodiments, the visual input may be analyzed to determine properties of the 3D surface of the face (or alternatively, any other organ or application surface on which the makeup or the material to be applied on). The properties may comprise a structure of the surface color of the surface (e.g., user's skin color, background color, or the like), texture (e.g. dry skin, pimples, pores, wrinkles, or the like), or the like. Additionally or alternatively, the visual input may be analyzed to determine locations or positioning of components of the surface, such as coordinates of points of interest, boundaries, exact locations of facial features, reference points, or the like. As an example, coordinates of the eyes, nose, eyebrows, lips, or the like, may be identified. In some exemplary embodiments, the analysis may be performed using image analysis techniques, machine learning, or the like.

On Step 320, a user input indicating a required result of makeup application may be obtained. In some exemplary embodiments, the user may be enabled to upload a photo of a desired look, to select a look from a catalogue, to select a look from multiple photos, or the like. Additionally or alternatively, the user may be enabled to upload sketches of the desired result, combination of different representations thereof, or the like. Additionally or alternatively, the user may be enabled to modify or update the look using a Graphics User Interface (GUI). In some embodiment, using a WYSIWYG (What You See Is What You Get) interface, for example, by clicking and dragging on a makeup mask depicting, for example, blush applied to the cheek area. In one embodiment, the user may be enabled to move the mask to a new location on the cheek, scale the mask to cover a smaller or larger area on the cheek, or the like. Additionally or alternatively, the user may be enabled to provide any other type of input indicating the requested result, such as verbal input, textual input, or the like.

On Step 330, a desired look may be determined based on the user input and on the face of the subject. In some exemplary embodiments, the desired look may be directly obtained from the user input, such as based on previous selections, a selection from a dynamic modeling of makeup on the face of the subject, or the like. Additionally or alternatively, the desired look may be dynamically generated based on the face of the subject (e.g., a photo thereof, 3D model thereof, or the like), based on properties of the face, or the like. The desired look may be an adaptation of the user input to the face of the subject. As an example, the user may provide a photography of a makeup design on a different person, having different facial properties, different head structure, different skin color, or the like. The desired look may be an adaptation of the makeup design on the face of the subject. As another example, the user input may comprise keywords or a description of the desired look, such as heavy makeup, smoked makeup, daily makeup, indication of colors to match, or the like. The desired look may be generated automatically based on the input.

On Step 340, the makeup application plan may be generated based on the 3D surface of the face and the desired look. In some exemplary embodiments, the makeup application plan may comprise instructions to an automatic makeup applicator for a process that provides the desired look, such as directions, mixture of materials in each timepoint and each location, or the like. Additionally or alternatively, the makeup application plan may comprise an optimized set of trajectories in 3D space of which the makeup applicator is configured to follow in order to achieve the desired look. Each trajectory may represent a path of the makeup applicator while applying the makeup material on the subject, a location as a function of time, (such as X,Y,Z coordinates thereof), or the like. Additionally or alternatively, each trajectory of the makeup applicator may be configured to emulate the movement of human expert in manually applying the material on the surface to achieve the desired result.

Additionally or alternatively, the makeup application plan may comprise an ordered sequence of instructions to the makeup applicator, indicating a target area on which the makeup is applied as a function of time, such as in each 0.1 second, 0.5 second, 1 second, or the like.

On Step 342, a material to be applied, an application property of an application of the material (such as intensity and consistency), and an application distance and orientation from which the material is to be applied may be determined for each target area in the 3D surface, in order to achieve the desired look in the target area. In some exemplary embodiments, the material to be applied on each target area may be comprised by a different composition of makeup materials, colors, or the like, based on the properties of the target area, properties of the surface, the desired look in this target area, or the like. Additionally or alternatively, the distance from which the material is applied may be calculated for each target area, based on properties of the target area, such as sensitivity of the organ, (as an example, about 3-5 centimeters from the eyes, 6-10 from the neck, or the like), based on the required intensively of material, the required area, or the like. As an example, the bigger the distance, the larger the application radius. For foundation, contour, blush, bronzer and highlighter, the application radius may range between 1-5 cm, while for eyeshadow and lip color it usually ranges between 0.5-2 cm. Additionally or alternatively, the application properties may comprise application pressure to be used when applying the material on the target area, the type of airbrush nozzle to be used while applying the material on the target aria, or the like. For airbrush makeup application, air pressure may range between 5-20 psi.

Additionally or alternatively, the applied material, the distance from which the material is applied and the other application properties may be related to each other. As an example, airbrush makeup applicators may be configured to perform a circular motion or forward-backward motion when applying foundation. Additionally or alternatively, the applied material, the distance from which the material is applied and the other application properties may be determined based on properties of the makeup applicator, such as the type pf the airbrushes actions, the nozzles, or the like.

Additionally or alternatively, the applied material, the distance from which the material is applied and the other application properties may be calculated based on safety considerations, such as response time of the automatic makeup applicator to a movement of the subject, sensitivity of the organ on which the makeup material is applied thereon, or the like; such as to ensure sufficient time to avoid injury of the subject. It may be noted that in some cases the range of motion of the subject may not necessarily be 100% free. Instead, the movement of the subject in some exemplary embodiments be limited by physical limitation that restricts the movement of the subject, such as using a chinrest, a foredream, straps, a combination thereof, or the like.

Additionally or alternatively, the estimated quantities of materials and the estimated time required to complete every trajectory, may be calculated, by taking into consideration parameters like air pressure, coverage, material viscosity, and the like, and communicated to the user by means of display, verbal communication, or the like.

On Step 346, one or more instructions that are configured to cause the automatic makeup applicator to apply the material from the application distance on the target area using the application property may be generated.

Referring now to FIG. 3B showing a flowchart diagram of a method, in accordance with some exemplary embodiments of the disclosed subject matter.

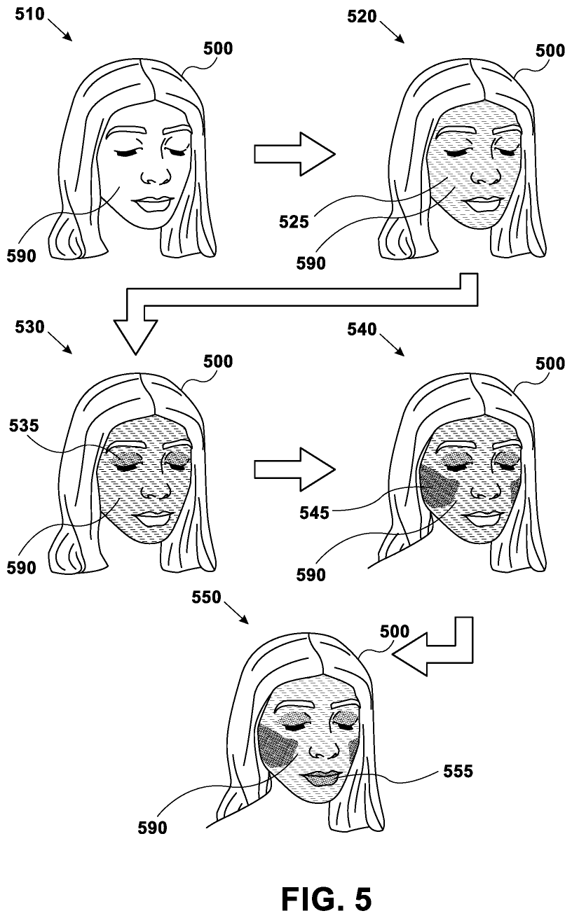

On Step 310b, a 3D model of the face of the subject may be obtained. In some exemplary embodiments, the 3D model of the face may be a digital representation of the face of the subject that can be manipulated and viewed from different angles. The 3D model may be generated using specialized software, 3D scanning techniques, modeling techniques, generative AI techniques, or the like. As an example, the 3D model may be automatically generated using a 3D scanner that is configured to capture the geometry and texture of the face of the subject, and then convert the data into a digital format. Additionally or alternatively, the 3D model may be generated based on other types of visual input capturing the face of the subject, such as the sensor readings obtained in Step 230 of FIG. 2A, the 3D surface of the face obtained in Step 310 of FIG. 3A, images of the user obtained in the simulation process, such as illustrated in FIG. 5 or the like.

On Step 330b, a desired look may be obtained. Step 330b may be similar to Step 330 of FIG. 3A. Additionally or alternatively, the desired look may be automatically generated based on a user input and the 3D model of a face, such as by applying the user input on the 3D model and dynamically adapting a desired look for the subject based on the 3D model.

On Step 340b, the makeup application plan may be generated based on the 3D surface of the face or 3D model of the subject.

In some exemplary embodiments, the makeup application plan may comprise instructions to utilize stencils, such as existing 2D stencils, self-folding 3D stencils, or the like.

On Step 350, a 4D stencil configured to be attached to the subject in order to may be designed. In some exemplary embodiments, the 4D stencil may be designed based on 3D model of the subject. The 4D stencil may be designed to obtain a certain makeup result in accordance with the makeup application plan, such as to enable applying fine line, sharp edges, or the like.

In some exemplary embodiments, the 4D stencils may be customized self-folding 3D stencils that may be custom fit to the face of the subject. The customized self-folding 3D stencils may be created based on analysis of a visual input scanning the face of the user, based on the desired look, based on the 3D model of the subject, or the like. The customized self-folding 3D stencils may be automatically personalized and adapted to the shape of the face of the subject, achieve a required result, such as certain shapes, fine liens, sharp edges or the like, that may not be feasible or applied accurately without the use of stencils, especially when utilizing airbrush techniques. Additionally or alternatively, the 4D stencils may sets forth an alternative to traditional 2D generic stencils.

On Step 352, the 4D stencil may be fabricated. In some exemplary embodiments, the 4D stencils may be generated using 4D printing technology. The customized self-folding 3D stencils may be created using programmable 4D printing, wherein after the fabrication process, the printed stencils react with parameters within the environment (humidity, temperature, voltage, or the like) and change its form accordingly. The self-folding stencils can conform perfectly to the user's face and enable maneuver-free and much less challenging material application.

In some exemplary embodiments, 4D printing may be configured to encode self-actuating deformation during the printing process, such that objects can be fabricated flat and then transformed into target 3D shapes. 4D printing may include printing a 3D structure, or a 2D structure capable of taking 3D form, such as by folding the 2D surface. The 4-th dimension involved in the 4D printing may be the time dimension, as the 3D object (e.g., 3D printed object, 2D printed surface that is folded to a 3D object, or the like) may change its form over time. The change of the form may be caused by heat, contact with another material, or the like. As an example, a Fused Deposition Modeling (FDM) printing technique may be utilized to extrude melted thermoplastic through a narrow nozzle, which stretches the material along the printing direction. The pre-stretch causes the material to shrink along the printing direction under heat. In addition to the shrinkage direction, the amount of shrinkage may be controlled through the printing thickness of each layer. As another example, a printed 2D flat sheet, e.g., the personalized stencil, may uniformly be heated with a hot water bath at a high temperature, such as about 90° C., and self-transform into the target 3D surface. As yet another example, the printed stencils (2D or 3D) may be automatically deformed when getting close to the user's face, or being in contact with a basis material applied to the face using the airbrush machine, or the like.

On Step 354, the 4D e.g., the customized self-folding 3D stencils) stencil may be attached to the face of the subject to obtain un updated 3D surface. In some exemplary embodiments, the customized self-folding 3D stencils may be automatically attached on the face of the subject in a predetermined location, and predetermined timing, in accordance with the calculated trajectories. Additionally or alternatively, the customized self-folding 3D stencils may be mounted on a fixture, or manually held and placed by the user on the exact location. In some exemplary embodiments, barcode may be printed on the stencils that can help locate a stencil in a scene and guide the user in its placement with respect to the location of points of interest in the scene like edges of the eyes or lips.

In some exemplary embodiments, the customized self-folding 3D stencils may be capable to morph into different forms in response to environmental stimulus, with the 4th dimension being the time-dependent shape change after the printing.

On Step 390b, the makeup application plan may be implemented while the 4D stencil is attached to the subject. After applying the mixed materials, the 4D custom stencils may be automatically removed, adjusted, replaced, or the like. Additional layers of material may or may not be applied over the material applied in accordance with 4D custom stencils.

Referring now to FIGS. 4A-4E showing schematic illustrations of an exemplary architecture, in accordance with some exemplary embodiments of the disclosed subject matter.

FIG. 4A shows a schematic illustration of an exemplary architecture of System 400. FIG. 4B shows a schematic illustration of a close-up on exemplary architectures of some components of System 400. FIG. 4C shows a schematic illustration of exemplary architectures of components of System 400. FIG. 4D illustrates a translation movement of components of System 400. FIG. 4E illustrates a rotational movement of components of System 400.

In some exemplary embodiments, System 400 may be an automatic makeup application system. System 400 may comprise an automatic makeup machine comprising a Robotic Arm 410 mounted on a Base Module 405. Robotic Arm 410 may be movable in translation movement in 3 axes, such as shown in FIG. 4D. System 400 may comprise one or more sensors for monitoring movement of a subject upon which System 400 acts, such as Camera 440.

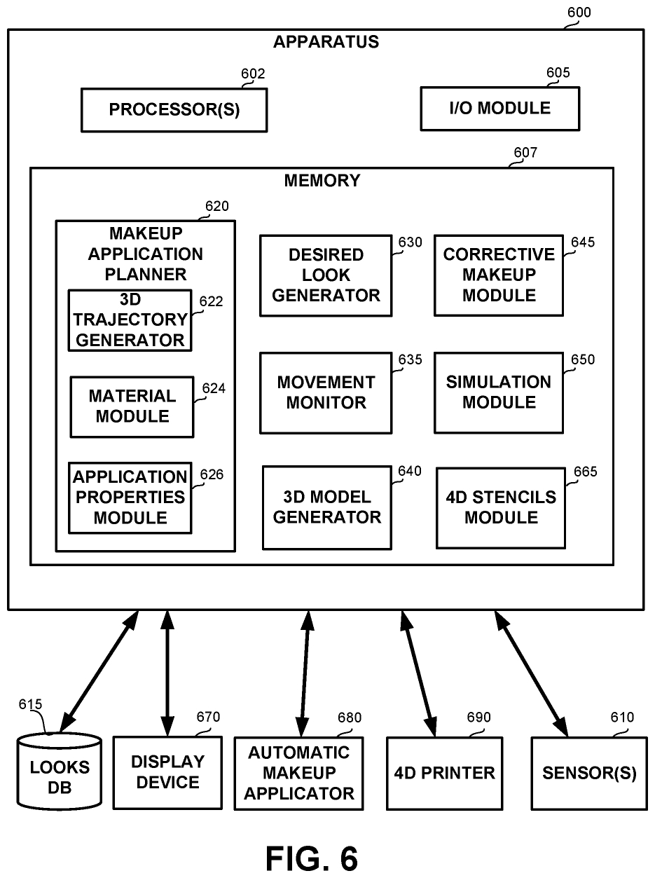

In some exemplary embodiments, one or more Motors 415 may be utilized to achieve the translation movement and the rotational movement, such as shown in FIG. 4C. Motors 415 may be of different types, including electric, hydraulic, pneumatic, or the like. Motors 415 may comprise linear actuators, each of which actuating one or more axis of movement (X, Y, and Z). Each linear actuator may be connected to a specific joint or Robotic Arm 410 to move it along the desired axis. The actuators may be placed on Robotic Arm 410, at the joints themselves, on Base Module 405, or the like. Movement of Robotic Arm 410 may be controlled by a motion controller (not shown), or a control unit (not shown) that receives commands or instructions from a computer or other control system, such as from Apparatus 600 illustrated in FIG. 6. The motion controller may be configured to control the linear actuators to move the arm along the desired path and trajectory. Accuracy of the movement of Robotic Arm 410 may be improved by incorporating sensors to measure the position and orientation of Robotic Arm 410. The sensors may be encoders, accelerometers, gyroscopes, or the like. The sensors may be configured to provide feedback to the motion controller to adjust the movement of Robotic Arm 410 as needed, in accordance with a makeup application plan and a movement of the subject.

In some exemplary embodiments, an Airbrush 420 may be mounted on Robotic Arm 410, using a Wrist Module 430. Wrist Module 430 may be configured to enable a rotational movement in 2 axes (e.g. pitch and yaw) of Airbrush 420, such as shown in FIG. 4E. The two axes rotational movement may be actuated by actuators such as Motors 415. As an example, one actuator may be used for rotation around the Z-axis, and the other actuator may be used for rotation around the Y-axis.

In some exemplary embodiments, System 400 may comprise an Air Compressor 455 configured to cause application of material via Airbrush 420. Air Compressor 455 may be configured to provide different air pressure levels in accordance with the makeup application plan.

In some exemplary embodiments, System 400 may comprise a Color Mixer 425 configured to provide a material to be applied by Airbrush 420. Color Mixer 425 may be configured to mix materials for applying makeup on the subject as defined by the makeup application plan.

In some exemplary embodiments, Airbrush 420 may be attachable to multiple alternative Nozzles 475 having different sizes and shapes. Nozzles 475 may be automatically selected, attached, or removed from Airbrush 420, to enable different application patterns.

Referring now to FIG. 5 showing a schematic illustration of an exemplary simulation, in accordance with some exemplary embodiments of the disclosed subject matter.

FIG. 5 illustrates a simulation of an outcome of the process of applying the makeup application plan on Subject 500 by an automatic makeup applicator, such as the machine illustrated in FIGS. 1A-1C, or 4A-4E. Intermediate Simulations 510-550 may be simulations of implementation of the instructions of the makeup application plan on a 3D model of Subject 500, to obtain a simulated outcome depicting Subject 500 wearing makeup in accordance with the makeup application plan. Intermediate Simulations 510-550 may be displayed to the user using a display device, such as similar to Device 195 illustrated in FIG. 1A, or any other display of a computing device accessible to the user.

Additionally or alternatively, Intermediate Simulations 510-550 may be portions of a video or a sequence of images representing the process of implementation of the instructions of the makeup application plan using the automatic makeup applicator. The video or the sequence of images may be configured to display each of the 3D trajectories of the makeup application plan, thereby making the process more predictable for the user or for the subject.

In some exemplary embodiments, each Intermediate Simulation of 510-550 may simulate a different application of makeup on the same or on a different target area of Subject 500. Each Intermediate Simulation of 510-550 may be an intermediate simulated outcome depicting Subject 500 wearing makeup in accordance with a partial application of the makeup application plan. Additionally or alternatively, each Intermediate Simulation of 510-550 may simulate an application of a different makeup material in accordance with a different portion of the makeup application plan. Each Intermediate Simulation of 510-550 may be configured to simulate a different or separate trajectory of makeup application plan.454

In some exemplary embodiments, Intermediate Simulation 510 may be configured to simulate an initial look of Subject 500, such as without wearing any makeup, prior to initiating application of makeup application plan, or the like. Intermediate Simulation 520 may be configured to simulate a first portion of the makeup application plan being applied on Intermediate Simulation 510, in accordance with a first 3D trajectory. Intermediate Simulation 520 may be configured to simulate a first layer of makeup on the face of Subject 500, such as Foundation Layer 525. Intermediate Simulation 510 may be configured to view previous makeup layers or portions of the makeup application plan configured to be applied prior to the first portion of the makeup application layer, such as contouring makeup, corrective makeup layers, or the like.

Intermediate Simulation 530 may be configured to simulate a second layer of makeup applied on Subject 500, in accordance with a second portion of the makeup application plan. Intermediate Simulation 530 may be configured to simulate the second layer of makeup on the face of Subject 500, such as Eyeshadow Layer 535. The second application layer may be applied on the first application layer, e.g., simulated on Intermediate Simulation 520.

Intermediate Simulation 540 may be configured to simulate a third layer of makeup applied on Subject 500, in accordance with a third portion of the makeup application plan. Intermediate Simulation 540 may be configured to simulate the third layer of makeup on the face of Subject 500, such as Blushing Layer 545. The third application layer may be applied on the second application layer, e.g., simulated on Intermediate Simulation 530.

Intermediate Simulation 550 may be configured to simulate a fourth layer of makeup applied on Subject 500, in accordance with a fourth portion of the makeup application plan. Intermediate Simulation 550 may be configured to simulate the fourth layer of makeup on the face of Subject 500, such as Lipstick Layer 555. The fourth application layer may be applied on the third application layer, e.g., simulated on Intermediate Simulation 540.

It may be noted that the same target area, such as Area 590 of the Face of Subject 500, may change in some intermediate simulated outcomes, in accordance with simulating different portions of the makeup application plan on the same area, such as one layer on the top of a previous layer. Accordingly, instead of simulating only a final outcome such as Simulation 550, with pixels in Area 590 representing one-step result, the pixels of Area 590 may be simulated in in initial look, color, texture, or the like, in Intermediate Simulation 510. Then the same pixels of Area 590 may be simulated with a Foundation Layer 525 above the initial look, color, texture in Intermediate Simulation 520. In Intermediate Simulation 530 the pixels of Area 590 may not be updated, while in Intermediate Simulation 540, the pixels of Area 590 may be updated because of adding Blush Layer 545. This results in more accurate and realistic simulation outcome that emulates the actual automatic application in accordance with the application plan, step by step, trajectory by trajectory, layer by layer, or the like. Furthermore, the user may be enabled to review every intermediate simulation and update or instruct the system to modify the specific relevant portion of the makeup application.

In some exemplary embodiments, the sequence of images (e.g., Intermediate Simulation of 510-550), video, or the like, may be configured to simulate the use of 4D stencils, as being carried out while applying the makeup application plan. Additionally or alternatively, the sequence of images (e.g., Intermediate Simulation of 510-550), video, or the like, may be configured to simulate a corrective makeup process being performed in accordance with the makeup application plan. As an example, Intermediate Simulation 520 may be configured to simulate a corrective makeup performed to blur imperfections of the face of Subject 500 using Foundation Layer 525. As another example, Intermediate Simulation 550 may be configured to simulate a corrective makeup fixing asymmetry of the lips of Subject 500 (the top part of the lip on the right is higher than the top part of the lip on the left) using Lipstick Layer 555 that correct the lips of Subject 500 to look symmetric. Additionally or alternatively, this asymmetry can be taken into account to generate a perfectly symmetric stencil and lip.

Referring now to FIG. 6 showing a block diagram of an apparatus, in accordance with some exemplary embodiments of the disclosed subject matter. An Apparatus 600 may be configured to support parallel user interaction with a real-world physical system and a digital representation thereof, in accordance with the disclosed subject matter.

In some exemplary embodiments, Apparatus 600 may comprise one or more Processor(s) 602. Processor 602 may be a Central Processing Unit (CPU), a microprocessor, an electronic circuit, an Integrated Circuit (IC) or the like. Processor 602 may be utilized to perform computations required by Apparatus 600 or any of its subcomponents.

In some exemplary embodiments of the disclosed subject matter, Apparatus 600 may comprise an Input/Output (I/O) module 605. I/O Module 605 may be utilized to provide an output to and receive input from a user or any other device associated therewith, such as, for example obtaining visual input capturing the user's face, providing a catalog of looks to the user and obtaining a selection of a desired look therefrom, obtaining user input indicative of the desired look, displaying makeup results to the user, providing instructions to other devices, or the like.

In some exemplary embodiments, I/O Module 605 may be utilized to obtain sensor readings from one or more Sensors 610. Sensors 610 may be configured to monitor movements of the subject on which Automatic Makeup Applicator 680 is configured to apply makeup on, or is already applying makeup on. In some exemplary embodiments, Sensors 610 may be connected to Automatic Makeup Applicator 680, may be a component thereof, or the like. Additionally or alternatively, Sensors 610 may be detached and not-directly related to Automatic Makeup Applicator 680.

In some exemplary embodiments, Apparatus 600 may comprise Memory 607. Memory 607 may be a hard disk drive, a Flash disk, a Random-Access Memory (RAM), a memory chip, or the like. In some exemplary embodiments, Memory 607 may retain program code operative to cause Processor 602 to perform acts associated with any of the subcomponents of Apparatus 600.

Additionally or alternatively, Apparatus 600 may be configured to control an Automatic Makeup Applicator 680, provide instructions thereto, manage automatic makeup application processes, or the like. Memory 607 may retain program code operative to cause Processor 602 to execute a computer program product or a software controlling Automatic Makeup Applicator 680, any other automatic makeup machine, an airbrushing robot, or the like. Automatic Makeup Applicator 680 may be configured to implement a predefined makeup application plan or portion thereof in order to achieve the desired look for the subject while taking into account the movement of the subject.

In some exemplary embodiments, Makeup Application Planner 620 may be configured to generate makeup application plan based on a visual input capturing the subject, based on the 3D surface of the face, based on a user input indicating the desired look, or the like. The makeup application plan may comprise instructions for an automatic makeup applicator to apply makeup materials on a subject in order to achieve a desired look for the subject. Makeup Application Planner 620 may be configured to obtain a 3D surface of a face of the subject, such as based on input from Sensors 610. Makeup Application Planner 620 may be further configured to obtain the desired look from Desired look Generator 625, directly from the user, or the like. In some exemplary embodiments, Desired look Generator 625 may be configured to determine the desired look based on a user input indicating a required result of makeup application on the face of the subject, such as based on a selection of the user from Looks Database 615, based on adaptation of the user input to the surface of the face of the subject, or the like.

In some exemplary embodiments, Makeup Application Planner 620 may be configured to generate instructions to Automatic Makeup Applicator 680 to apply the makeup materials from a predefined location in space that is distant from a surface of the face by a defined distance. Makeup Application Planner 620 may be configured to utilize a 3D Trajectory Generator 622 to calculate movement instructions that yield a 3D trajectory to be followed by Automatic Makeup Applicator 680 in order to achieve the desired look. Additionally or alternatively, 3D Trajectory Generator 622 may be configured to generate different application trajectories for different nozzles or components of Automatic Makeup Applicator 680.

Additionally or alternatively, Makeup Application Planner 620 may be configured to utilize Material Module 624 to determine material application instructions each of which indicating a material to be applied on each application location on the face of the subject. Material Module 624 may be configured to calculate composition of the makeup material required for the certain location, such as based on propertied of the face of the subject and the desired look. Additionally or alternatively, Makeup Application Planner 620 may be configured to utilize Application Properties Module 626 to calculate application properties to be implemented by Automatic Makeup Applicator 680, that are required to achieve the desired look, such as the application distance from which the material is to be applied on the target area, in order to achieve the desired look in the target area. Additionally or alternatively, Application Properties Module 626 may be configured to determine pressure to be used when applying the material on the target area, the type or size of the nozzle to be utilized when applying the material, the type and time of use of the pod to be utilized when applying the material, or the like. Makeup Application Planner 620 may be may be configured to generate one or more instructions that are configured to cause Automatic Makeup Applicator 680 to apply the material determined by Material Module 624 from the application distance determined by Application Properties Module 626, in accordance with the pressure property or any other application property determined by Application Properties Module 626, on the target area determined with respect to the location on the 3D trajectory determined by 3D Trajectory Generator 622.

It may be noted that Application Properties Module 626 may be configured to determine different application properties for different target areas in the subject face, e.g., different distances, different pressure, or the like.

Additionally or alternatively, Makeup Application Planner 620 may be configured to generate the makeup application plan based on safety considerations or to avoid injury of the subject, such as the response time of Automatic Makeup Applicator 680 to a movement of the subject, to ensure sufficient time to avoid injury of the subject, or the like.

Additionally or alternatively, Makeup Application Planner 620 may be configured to automatically and continuously update the makeup application plan during application thereof by Automatic Makeup Applicator 680, such as after implementing each predefined portion of the makeup application, in each predetermined time, or the like, based on identification of movement of the subject by Movement Monitor 635, or the like. In some exemplary embodiments, Movement Monitor 635 may be configured to analyze sensor readings obtained from Sensors 610, or other sensors associated with Automatic Makeup Applicator during implementation of the makeup application plan. Makeup Application Planner 620 may be configured to dynamically update, or regenerate the makeup application plan in response to Movement Monitor 635 identifying a movement of the subject. Makeup Application Planner 620 may be configured to dynamically update makeup plan by modifying the instruction based on the movement of the subject so as to maintain the defined distance, and the other application properties.

Additionally or alternatively, Makeup Application Planner 620 may be configured to instruct 4D Stencils Module 665 to generate 4D stencil configured to be attached to the subject during application of the makeup application plan or a portion thereof. Automatic Makeup Applicator 680 may be instructed to implement the makeup application plan while the 4D stencil is attached to the subject, such as to enable creating certain shapes, lines, or the like. 4D Stencils Module 665 may be configured to design 4D stencil based on a 3D model of the subject, 3D Model Generator, based on input from Sensors 610, or the like. 4D Stencils Module 665 may be configured to instruct a designated device to fabricate the 4D stencils, such as 4D Printer 690, a designated component of Automatic Makeup Applicator 680, or the like. Additionally or alternatively, 4D Stencils Module 665 may be configured to instruct the user or Automatic Makeup Applicator 680 to attach a 4D stencil on the subject in a predetermined location, detach the 4D stencil, or the like.

Additionally or alternatively, Makeup Application Planner 620 may be configured to the makeup application plan based on corrective makeup instruction or measurements determined by Corrective Makeup Module 645. Corrective Makeup Module 645 may be configured to identify face defects that may disable reaching the desired look, such as face dissimilarity, skin imperfections, pigmentation, scars, unsuitable sizes of certain organs, and determine instructions to perform corrective makeup to overcome such defects. Additionally or alternatively, Corrective Makeup Module 645 may be configured to identify such face imperfections and determine a corrective makeup thereof in order to enhance the desired look, even in the absence of user input indicative thereof. Corrective Makeup Module 645 may be configured to determine instructions that enhance the appearance of facial features, by create an illusion of balance and symmetry using the makeup material. Corrective Makeup Module 645 may be configured to identify the areas in the face that require correction, determine the shades of makeup material to be utilized to highlight or contour specific areas of the face, in order to achieve a desired look. Corrective Makeup Module 645 may be configured to provide instructions for Material Module 624 to generate the accurate material composition that achieves the light and dark shades and colors to highlight and contour features, creating the effect of balance and proportion, or the like. Additionally or alternatively, Corrective Makeup Module 645 may be configured to provide instructions for Application Properties Module to set application properties that enable illusions of shapes, accurate highlight, accurate contouring, or the like.

In some exemplary embodiments, Simulation Module 650 may be configured to simulate an outcome of the process of applying the makeup application plan on the subject. Simulation Module 650 may be configured to simulate implementation of the instructions of the makeup application plan generated by Makeup Application Planner 620 on a 3D model of the subject generated by 3D Model Generator 640. The simulated outcome may depict the subject wearing makeup in accordance with the makeup application plan layer by layer. As an example, simulated outcome may comprise simulating a certain application of makeup on a target area of the subject and simulating a second application of makeup on the target area, independently or above the first certain application of makeup. Additionally or alternatively, Simulation Module 650 may be configured to generate a series of intermediate simulated outcomes depicting the subject wearing makeup in accordance with separated portions of the application of the makeup application plan. The intermediate simulated outcome may be displayed to the user on a Display Device 670, to enable the user review the application plan.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising.” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

1-26. (canceled)

27. A method comprising:
obtaining a makeup application plan, the makeup application plan comprises
instructions for an automatic makeup applicator, the instructions, when implemented by the automatic makeup applicator, are configured to apply makeup materials on a subject in order to achieve a desired look for the subject; implementing by the automatic makeup applicator a portion of the makeup application plan;
obtaining sensor readings from a sensor during said implementing, wherein the sensor is configured to monitor movements of the subject;
in response to identifying, based on the sensor readings, a movement of the subject, updating the makeup application plan, whereby obtaining a dynamically updated makeup application plan; and
implementing the dynamically updated makeup application plan or portion thereof in order to achieve the desired look for the subject while taking into account the movement of the subject and an implementation of the portion of the makeup application plan.

28. The method of claim 27,
wherein the instructions of the makeup plan comprise an instruction to apply the makeup materials from a predefined location in space that is distant from a surface of the face by a defined distance; and
wherein said updating the makeup plan comprises modifying the instruction based on the movement of the subject so as to maintain the defined distance.

29. The method of claim 27,
wherein the instructions comprise movement instructions that yield a 3D trajectory to be followed by the automatic makeup applicator in order to achieve the desired look; and
wherein the instructions comprise material application instructions, each of which indicating an application location, a material to be applied and application properties to be implemented by the automatic makeup applicator.

30. The method of claim 27, wherein said obtaining the makeup application plan comprises:
obtaining a three-dimensional (3D) surface of a face of the subject; obtaining the desired look, wherein the desired look is determined based on a user input indicating a required result of makeup application on the face of the subject; and
generating the makeup application plan based on the user input and based on the 3D surface of the face.

31. The method of claim 30, wherein said generating comprises:
determining, for a target area in the 3D surface of the face, a material to be applied, an application property of an application of the material, and an application distance and orientation from which the material is to be applied on the target area, in order to achieve the desired look in the target area; and
generating one or more instructions that are configured to cause the automatic makeup applicator to apply the material from the application distance and orientation on the target area using the application property,
wherein the application property comprises application pressure to be used when applying the material on the target area.

32. The method of claim 31, wherein said generating is performed with respect to a first target area and a second target area, wherein the application distance at the first target area is different than the application distance at the second target area.

33. The method of claim 31, wherein said generating is performed with respect to a first target area and a second target area, wherein the application property is a pressure to be used by automatic makeup applicator, wherein the application distance at the first target area is equal to the application distance at the second target area, wherein the pressure to be used by the automatic makeup applicator at the first target area is different than the pressure at the second target area.

34. The method of claim 30, wherein said generating is performed based on safety considerations, wherein the safety considerations include response time of the automatic makeup applicator to a movement of the subject, whereby ensuring sufficient time to avoid injury of the subject.

35. The method of claim 27, wherein said updating is performed to avoid injury of the subject.

36. The method of claim 27, further comprises:
simulating an outcome of the process of applying the makeup application plan on the subject, wherein said simulating comprises simulating implementation of the instructions of the makeup application plan on a 3D model of the subject, whereby obtaining a simulated outcome depicting the subject wearing makeup in accordance with the makeup application plan, wherein said simulating the implementation of the instructions include simulating a first application of makeup on a target area of the subject and simulating a second application of makeup on the target area; and
displaying the simulated outcome,
wherein said simulating comprises generating an intermediate simulated outcome depicting the subject wearing makeup in accordance with a partial application of the makeup application plan; and wherein said method comprises displaying the intermediate simulated outcome.

37. The method of claim 27, wherein the makeup application plan comprises an instruction to generate a four-dimensional (4D) stencil configured to be attached to the subject; wherein the method further comprises fabricating the 4D stencil; wherein said implementing is performed while the 4D stencil is attached to the subject, wherein the 4D stencil is fabricated based on a three-dimensional (3D) model of the subject.

38. The method of claim 27, wherein the automatic makeup applicator comprises an airbrush that is movable at 5 degrees of freedom, the airbrush is capable of translation movement in 3 axes and rotational movement in 2 axes.

39. The method of claim 38, wherein the airbrush having multiple nozzles having variable sizes and shapes, wherein the makeup application plan defines a first application trajectory for a first nozzle and a second application trajectory for a second nozzle, and wherein the makeup application plan defines a relative order of application between the first nozzle and the second nozzle.

40. A machine comprising:
a robotic arm movable in 5 degrees of freedom, the 5 degrees of freedom comprise translation movement in 3 axes and rotational movement in 2 axes; an airbrush mounted on said robotic arm;
a sensor for monitoring movement of a subject; and
a control unit for controlling movement of said robotic arm in accordance with a makeup application plan, said control unit is further configured to control application of said airbrush in accordance with the makeup application plan, wherein said control unit is configured to modify the makeup application plan based on sensor readings from said sensor.

41. The machine of claim 40, further comprises an air compressor, said air compressor is configured to cause application of material via said airbrush, wherein said control unit is configured to instruct said air compressor to provide different air pressure levels in accordance with the makeup application plan.

42. The machine of claim 40, further comprises a material mixer for providing a material to be applied by said airbrush, wherein the makeup application plan defines different materials to be mixed for applying makeup on the subject.

43. The machine of claim 40, wherein said airbrush is attachable to multiple alternative nozzles having different sizes and shapes, thereby enabling different application patterns by said airbrush, wherein said machine is configured to automatically attach and detach nozzles from said airbrush.

44. The machine of claim 40, wherein said machine is coupled to a stencil fabricator for fabricating a four-dimensional (4D) stencil that is configured to be attached to the subject while applying makeup in accordance with the makeup application plan.

45. The machine of claim 40, further comprises a proximity sensor monitoring a distance of said airbrush from physical objects.

46. A computerized apparatus having a processor, the processor being adapted to perform the steps of:
obtaining a makeup application plan, the makeup application plan comprises instructions for an automatic makeup applicator, the instructions, when implemented by the automatic makeup applicator, are configured to apply makeup materials on a subject in order to achieve a desired look for the subject; implementing by the automatic makeup applicator a portion of the makeup application plan;
obtaining sensor readings from a sensor during said implementing, wherein the sensor is configured to monitor movements of the subject;
in response to identifying, based on the sensor readings, a movement of the subject, updating the makeup application plan, whereby obtaining a dynamically updated makeup application plan; and
implementing the dynamically updated makeup application plan or portion thereof in order to achieve the desired look for the subject while taking into account the movement of the subject and an implementation of the portion of the makeup application plan.
